(19) United States
(12) Patent Application Publication
(10) Pub. No.: US 2009/0122818 A1
(43) Pub. Date: May 14, 2009

(54) ELECTRONIC SELECTABLE TWO-COLOR SOLID STATE LASER

(76) Inventors: John E. Nettleton, Fairfax Station, VA (US); Dallas N. Barr, Woodbridge, VA (US)

Correspondence Address: DEPARTMENT OF THE ARMY;CECOM LEGAL OFFICE, FORT BELVOIR, AMSEL-LG-BELV, 10235 BURBECK ROAD, FORT BELVOIR, VA, 22060-5806, US

(21) Appl. No.: 11/686,332

(22) Filed: Mar. 14, 2007

(51) Int. Cl. H01S 3/094

(52) U.S. Cl. 372/23

(57) ABSTRACT

An electronic selectable, two color solid state laser comprising a laser diode pump and a plurality of discrete optical elements disposed serially and sharing a common optical axis. The optical components include a laser rod of gain material having a laser emission wavelength, a polarizer cube, a means for compensating for OPO crystal polarization, an electro-optic active Q-switch having input terminals for applying a voltage across the Q-switch, and an OPO crystal. The laser rod has an input end face coated with an anti-reflector at the laser diode pump wavelength and a high reflector at the laser emission wavelength. The OPO crystal has an input end face coated with an anti-reflector at the laser emission wavelength and a high reflector at the OPO wavelength, and an output end face coated with a partial reflector at the laser emission wavelength and a partial reflector at the OPO wavelength.

### GOVERNMENT INTEREST

The invention described herein may be manufactured, used, sold, imported, and/or licensed by or for the Government of the United States of America.

### FIELD OF THE INVENTION

The present invention generally relates to lasers, and more particularly, to solid state lasers.

### BACKGROUND OF THE INVENTION

Laser designators are becoming an increasingly vital component in high precision targeting engagements. The laser designator operator surgically selects a target by placing the high energy laser beam onto the target. The laser beam on the target serves as a guide to a high precision munition which will strike the target with uncanny accuracy.

Unfortunately, the output of the laser designator is not eye-safe. In fact, it is very non-eye-safe. In fact most militaries prohibit training with a non-eye-safe laser designator. Additionally, many militaries forbid the use of an non-eye-safe laser designator as a range finder with allies in the area.

### SUMMARY OF THE INVENTION

It is therefore an object of the invention to make the development and fabrication of a very compact laser designator with eye-safe laser output possible.

This and other objects of the invention are achieved by an electronic selectable, two color solid state laser comprising a laser diode pump and a plurality of discrete optical elements disposed serially and sharing a common optical axis. The optical components include a laser rod of gain material having a laser emission wavelength, a polarizer cube, a quarter wave plate, an electro-optic active Q-switch having input terminals for applying a voltage across it, and an OPO crystal. The laser rod has an input end face coated with an anti-reflector at the laser diode pump wavelength and a high reflector at the laser emission wavelength. The OPO crystal has an input end face coated with an anti-reflector at the laser emission wavelength and a high reflector at the OPO wavelength, and an output end face coated with a partial reflector at the laser emission wavelength and a partial reflector at the OPO wavelength.

Another aspect of the invention involves an electronic selectable, two color solid state laser cavity comprising a plurality of discrete optical elements disposed serially and sharing a common optical axis. The optical components include a laser rod of gain material having a laser emission wavelength, a polarizer cube, a quarter wave plate, an electro-optic active Q-switch having input terminals for applying a voltage across it, and an OPO crystal. The laser rod has an input end face coated with an anti-reflector and coated with a high reflector at the laser emission wavelength. The OPO crystal has an input end face coated with an anti-reflector at the laser emission wavelength and a high reflector at the OPO wavelength, and an output end face coated with a partial reflector at the laser emission wavelength and a partial reflector at the OPO wavelength.

The invention produces a repetition rated laser designator system more efficiently. The fabrication of the electronic selectable, two color solid state laser can be done using batch processing. Large rectangular, pre-coated optical components can be joined together, optically aligned to form the laser cavity and then sliced to produce modules. This batch process can greatly reduce the overall fabrication costs of the module.

The extremely small size of a laser cavity allows for construction of a very compact, and lightweight, laser designator. The electronic selectable, two color solid state laser is a module that requires none of the labor extensive alignment procedures associated with conventional laser range finders and designators. No optical holders have to be fabricated; no complex engineering is required to design the optical cavity; and no precise laser cavity alignments are required. Production labor and material costs are greatly reduced. The modularity lends to ease of design for different laser diode pump sources. The laser can be incorporated in single bar or multi-bar, array laser diode pumped system. The energy of the pump source (e.g., drive electronics) can be tailored for the specific mission (e.g., long range vs. medium range performance) without forcing all of the systems to meet the high demand requirements of the few.

In particular, the laser cavity is configured for optimal absorption for diode laser pumping over broad temperature ranges. The electronic selectable, two color solid state laser is designed to be pumped by laser diode arrays from the end of the Nd:YAG rod (end pumping). The length of the cavity has been designed to absorb nearly all of the laser diode pump output.

The electronic selectable, two color solid state laser may be used as the laser source in very compact, repetition rated laser range finders or laser designators. It has an internally coupled OPO cavity for generation of eye safe laser output for eye safe laser operation. Its compact design also lends itself to placement in other laser-based portable and hand-held devices. These may be medical devices, industrial tools or scientific equipment that would benefit from the size and weight reduction, dependable performance, and low cost of the laser.

To the accomplishment of the foregoing and related ends, the invention provides the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 shows an electronic selectable, two color solid state laser.

FIG. 2 shows the output of the laser of FIG. 1 as a function of the voltage across the Q-switch.

In the detailed description that follows, identical components have been given the same reference numerals.

### DETAILED DESCRIPTION

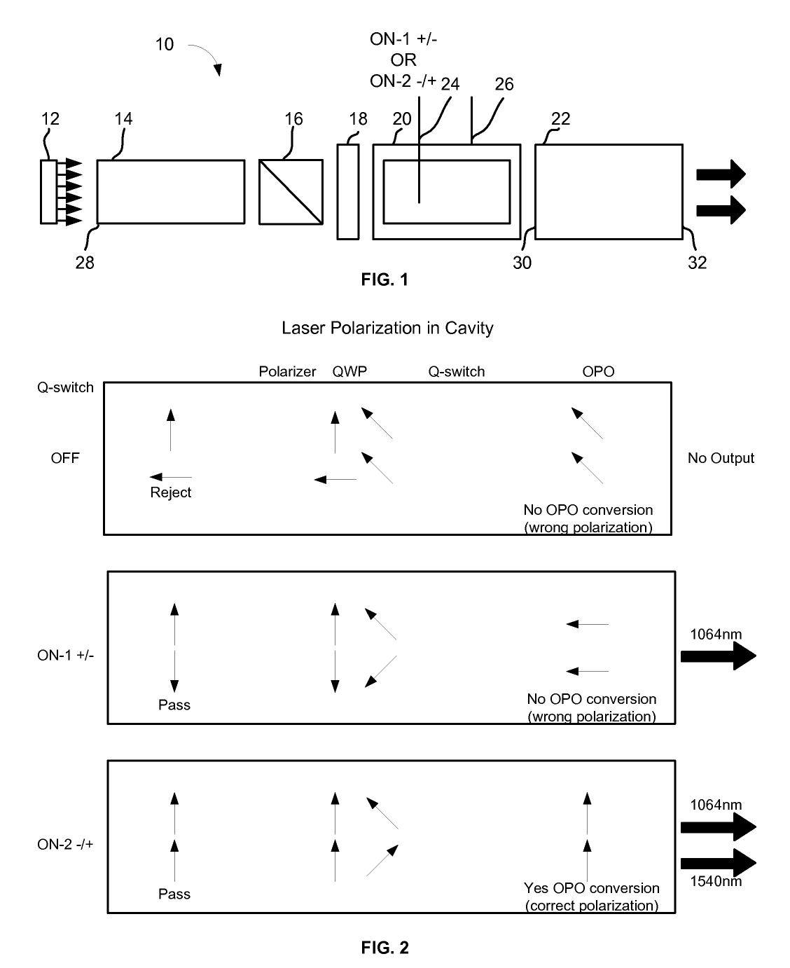

FIG. 1 shows an electronic selectable, two color solid state laser 10 comprising a laser diode pump 12 and a plurality of discrete optical elements 14, 16, 18, 20, and 22, disposed serially and sharing a common optical axis. The optical components include a laser rod 14 of gain material, a polarizer cube 16, a quarter wave plate 18, an electro-optic active Q-switch 20 having input terminals 24 and 26 for applying a voltage across the Q-switch, and an OPO crystal 22.

The laser rod 14 has an input end face 28 coated with an anti-reflector (AR) at the laser diode pump wavelength and a high reflector (HR) at the laser emission wavelength of the laser rod The polarization cube and quarter wave plate combination must provide a high round trip extinction and also have a high damage threshold to withstand intra-cavity fluences. In addition, these components must have high round trip transmission when further combined with the activated Q-Switch crystal. The OPO crystal 22 has an input end face 30 coated with an anti-reflector (AR) at the laser emission wavelength and a high reflector (HR) at the OPO wavelength. The OPO crystal 22 has an output end face 32 coated with a partial (e.g., −60%) reflector (PR) at the laser emission wavelength and a partial (e.g., −60%) reflector (PR) at the OPO wavelength. Output face 32 and Nd:YAG input face 28 form the short wavelength laser resonator while face 32 and face 30 form the OPO (long wavelength) resonator. By changing the drive voltage polarity to the active Q-switch the polarization of the shorter laser wavelength is changed which acts as a switch for the longer wavelength output.

A particular set of values based on the 1064 nanometer (nm) pulsed output of a repetition rate laser designator is set forth below. It will be appreciated that these values are by way of example only.

### EXAMPLE

Laser diode pump wavelength: 808 nm

Laser emission wavelength: 1064 nm.

OPO wavelength: 1540 nm.

Laser rod gain material: Nd:YAG

Q-switch material: LiNbO3, KTP, RTP, KD*P, or BBO.

OPO material: KTA or KTP.

The polarity of the lasing is selected by selecting the polarity of the high voltage applied across the active Q-switch 20. The OPO crystal 22 is internal to the laser cavity. It is an intra-cavity OPO. The OPO crystal 22 is coated for lasing operation at both the laser emission wavelength and the OPO wavelength. The output laser wavelength or color is selected through operation of the electro-optic, active Q-switch 20.

FIG. 2 shows the output of the laser as a function of the voltage across the Q-switch 20.

(1) When the active Q-switch 20 is off (no voltage applied), the polarization in the laser cavity depicted in FIG. 1 is such that the combined quarter wave plate 18 and polarizer cube 16 reject or hold-off the cavity from lasing which allows the laser rod 14 of gain material to store energy. Most OPO crystals will also have polarization wave plate effects so the nominal quarter wave plate and Q-switch crystal will have to compensate for the OPO crystal polarization. Accordingly, the device includes a means for compensating for the OPO crystal polarization. This can be done through a combination of rotation of the quarter wave plate and the application of a direct current (DC) high voltage bias on the electrodes of the Q-switch crystal to accomplish hold-off. In some cases a polarization compensator (e.g. a Berek Polarization Compensator) may be needed to replace the quarter wave plate in the laser.

(2) When the active Q-switch 20 is turned on in the ON-1 polarity (+/−), the polarity of the laser energy within the cavity depicted in FIG. 1 does not match that of the OPO crystal 22, so there is no conversion and the laser emission wavelength output is produced.

(3) When the active Q-switch is turned on in the ON-2 polarity (−/+), the polarity of the laser energy within the cavity depicted in FIG. 1 matches the polarity of the OPO crystal 22 and a certain percentage is converted. Both the laser emission wavelength and the OPO wavelength are transmitted out of the OPO crystal 22. To remove the laser emission wavelength, a simple long-pass filter can be inserted into the optical output path outside the cavity (note: this filter must be removed for operation at the laser emission wavelength). Thus, when the polarity of the Q-switch voltage is changed electronically, the output wavelength of the laser is changed.

Although the invention has been shown and described with respect to certain preferred embodiments, it is obvious that equivalent alterations and modifications will occur to others skilled in the art upon the reading and understanding of this specification and the annexed drawings. In particular regard to the various functions performed by the above described components (assemblies, devices, sensors, circuits, etc), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

What is claimed is:

1. An electronic selectable, two color solid state laser comprising:
a laser diode pump and a plurality of discrete optical elements disposed serially and sharing a common optical axis, the optical components including a laser rod of gain material having a laser emission wavelength, a polarizer cube, a means for compensating for OPO crystal polarization, an electro-optic active Q-switch having input terminals for applying a voltage across the Q-switch, and an OPO crystal,
wherein the laser rod has an input end face coated with an anti-reflector at the laser diode pump wavelength and a high reflector at the laser emission wavelength, and the OPO crystal has an input end face coated with an anti-reflector at the laser emission wavelength and a high reflector at the OPO wavelength, and an output end face coated with a partial reflector at the laser emission wavelength and a partial reflector at the OPO wavelength.

2. The laser recited in claim 1 wherein the means for compensating for OPO crystal polarization includes one of a quarter wave plate or polarization compensator.

3. The laser recited in claim 1 wherein the partial reflectors reflect about 60% of the incoming radiation.

4. The laser recited in claim 1 wherein the gain material is Nd:YAG.

5. The laser recited in claim 1 wherein the OPO material is KTA or KTP.

6. The laser recited in claim 1 wherein the Q-switch material is LiNbO3, KTP, RTP, KD*P, or BBO.

7. The laser recited in claim 1 wherein the laser diode pump wavelength is about 808 nm.

8. The laser recited in claim 1 wherein the laser emission wavelength is 1064 nm.

9. The laser recited in claim 1 wherein the OPO wavelength is about 1540 nm.

10. An electronic selectable, two color solid state laser comprising:
a laser diode pump and a plurality of discrete optical elements disposed serially and sharing a common optical axis, the optical components including a Nd:YAG laser rod of gain material having a laser emission wavelength of 1064 nm, a polarizer cube, a means for compensating for OPO crystal polarization, an electro-optic active Q-switch having input terminals for applying a voltage across the Q-switch, and an OPO crystal,
wherein the laser rod has an input end face coated with an anti-reflector at the laser diode pump wavelength of about 808 nm and a high reflector at the laser emission wavelength of 1064 nm, and the OPO crystal has an input end face coated with an anti-reflector at the laser emission wavelength of 1064 nm and a high reflector at the OPO wavelength of about 1540 nm, and an output end face coated with a partial reflector at the laser emission wavelength of 1064 nm and a partial reflector at the OPO wavelength of about 1540 nm.

11. The electronic selectable, two color solid state laser recited in claim 10, wherein the means for compensating for OPO crystal polarization includes one of a quarter wave plate or polarization compensator.

12. An electronic selectable, two color solid state laser cavity comprising:
a plurality of discrete optical elements disposed serially and sharing a common optical axis, the optical components including a laser rod of gain material having a laser emission wavelength, a polarizer cube, a means for compensating for OPO crystal polarization, an electro-optic active Q-switch having input terminals for applying a voltage across the Q-switch, and an OPO crystal,
wherein the laser rod has an input end face coated with an anti-reflector and coated with a high reflector at the laser emission wavelength, and the OPO crystal has an input end face coated with an anti-reflector at the laser emission wavelength and a high reflector at the OPO wavelength, and an output end face coated with a partial reflector at the laser emission wavelength and a partial reflector at the OPO wavelength.

13. The electronic selectable, two color solid state laser recited in claim 12, wherein the means for compensating for OPO crystal polarization includes one of a quarter wave plate or polarization compensator.

14. The laser cavity recited in claim 12 wherein the partial reflectors reflect about 60% of the incoming radiation.

15. The laser cavity recited in claim 12 wherein the gain material is Nd:YAG.

16. The laser cavity recited in claim 12 wherein the OPO material is KTA or KTP

17. The laser cavity recited in claim 12 wherein the Q-switch material is LiNbO3, KTP, RTP, KD*P, or BBO.

18. The laser cavity recited in claim 12 wherein the laser emission wavelength is 1064 nm.

19. The laser cavity recited in claim 12 wherein the OPO wavelength is about 1540 nm.

20. An electronic selectable, two color solid state laser cavity comprising:
a plurality of discrete optical elements disposed serially and sharing a common optical axis, the optical components including a Nd:YAG laser rod of gain material having a laser emission wavelength of 1064 nm, a polarizer cube, a quarter wave plate, an electro-optic active Q-switch having input terminals for applying a voltage across the Q-switch, and an OPO crystal,
wherein the laser rod has an input end face coated with an anti-reflector at a wavelength of 808 nm and a high reflector at the laser emission wavelength of 1064 nm, and the OPO crystal has an input end face coated with an anti-reflector at the laser emission wavelength of 1064 nm and a high reflector at the OPO wavelength of about 1540 nm, and an output end face coated with a partial reflector at the laser emission wavelength of 1064 nm and a partial reflector at the OPO wavelength of about 1540 nm.
